(19) United States
(12) Patent Application Publication
(10) Pub. No.: US 2009/0164434 A1
(43) Pub. Date: Jun. 25, 2009

(54) DATA SEARCH APPARATUS AND DATA SEARCH METHOD

(75) Inventor: Shigeaki Sakurai, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/335,615

(22) Filed: Dec. 16, 2008

(30) Foreign Application Priority Data
Dec. 25, 2007 (JP) 2007-331988

(51) Int. Cl. G06F 17/30; G06F 15/18; G06G 7/62

(52) U.S. Cl. 707/3; 706/16; 703/13

(57) ABSTRACT

A data search apparatus includes an obtaining unit that obtains a content and a first metadata corresponding to the content and including at least a search key indicating an object of the content; a feature amount computing unit that computes a feature amount indicating a feature of the content from the obtained content; a learning-data storing unit that stores a learning-data that correspondingly includes the first metadata corresponding to each of the obtained content and the computed feature amount; a learning-data reconstructing unit that reconstructs the learning-data by generating a second metadata from the first metadata included in the learning-data stored in the learning-data storing unit so that the second metadata includes all search keys in the first metadata of all the learning-data, and by replacing the first metadata by the second metadata in learning-data; and a model generating unit that generates a model from the learning-data, the model being a coefficient matrix indicating a relation between the feature amount and the search key in the generated the first metadata.

### CROSS-REFERENCE TO RELATED APPLICATIONS

This application is based upon and claims the benefit of priority from the prior Japanese Patent Application No. 2007-331988, filed on Dec. 25, 2007; the entire contents of which are incorporated herein by reference.

### BACKGROUND OF THE INVENTION

1. Field of the Invention

The present invention relates to a data search apparatus and a data search method for searching data.

2. Description of the Related Art

In the advancing computer environment, an individual or an organization can easily store a large amount of data including moving images, still images, speeches, texts, and the likes, and there is a need of effectively using the data. Although it is demanded that the stored data be instantly found as soon as the data is required, the desired data is often buried in the large amount of data. As a result, it takes a long time to find the desired data, or, in the worst case, the desired data cannot be found.

To solve such a problem, the following technology is disclosed in “Quantification Method of Diverse Kansei Quality for Emotional Design Application of Product Sound Design”, Hideyoshi Yanagisawa, Tamotsu Murakami, Shogo Noguchi, Koichi Ohtomi, and Rika Hosaka, Proceedings of DETC '07 ASME 2007 Design Engineering Technical Conference and Computers and Information in Engineering Conference, Las Vegas, Nev., USA, Sep. 4-7, 2007. The technology includes collecting questionnaire data from a plurality of examinees to see which one of a word pair is closer to a given speech using a plurality of word pairs, and modeling relations between the speech data and a physical feature amount of the speech, such as a frequency of the speech. With this technology, the data indicative of the closer one of the word pair is regarded as sensitivity feature amount indicative of the sensitive feature of the speech data. When unknown speech data is given, the sensitivity feature amount of the given speech data is measured and referenced so that the speech data can be designed compliant with the design concept.

However, the above technology involves a problem that the data needs to be collected from a lot of examinees to collect the sensitivity feature amount of the speech data, and it is highly burdensome to prepare for collecting a lot of speech data to be searched.

On the other hand, there is a lot of websites that allows many people to share metadata as well as data such as the moving images, the still images, the speech, and the texts by applying the metadata called a social tag to the data. With such a background, data mining technologies in the websites are actively studied.

One approach to instantly find the desired data from the large amount of data is to set a metadata that features the content of the data to each data. Although the metadata can be automatically applied to the data to a certain extent, the automatically applied metadata is not sufficiently precise, and therefore it is hard to instantly find the desired data based on the metadata. On the other hand, it is also possible that a user manually applies the metadata at the time of storing the data. However, applying the metadata requires a considerable amount of time and energy, and therefore it is hard to manually apply the metadata to all the data.

### SUMMARY OF THE INVENTION

According to one aspect of the present invention, a data search apparatus includes an obtaining unit that obtains a content and a first metadata corresponding to the content and including at least a search key indicating an object of the content; a feature amount computing unit that computes a feature amount indicating a feature of the content from the content obtained by the obtaining unit; a learning-data storing unit that stores a learning-data that correspondingly includes the first metadata corresponding to each of the content obtained by the obtaining unit and the feature amount computed by the feature amount computing unit; a learning-data reconstructing unit that reconstructs the learning-data by generating a second metadata from the first metadata included in the learning-data stored in the learning-data storing unit so that the second metadata includes all search keys in the first metadata of all the learning-data, and by replacing the first metadata by the second metadata in learning-data; and a model generating unit that generates a model from the learning-data, the model being a coefficient matrix indicating a relation between the feature amount and the search key in the second metadata generated.

According to another aspect of the present invention, a data search apparatus includes a content storing unit that correspondingly stores a content and a feature amount indicating a feature of the content; a model storing unit that stores a model that is a coefficient matrix representing a relation between the feature amount and a search key of metadata including at least a search key indicating an object of the content; a receiving unit that receives an input of the metadata; a feature amount estimating unit that estimates the feature amount based on the metadata received by the receiving unit and the model stored in the model storing unit; and a selecting unit that compares the feature amount corresponding to each of the content stored in the content storing unit to the feature amount estimated by the feature amount estimating unit, and that selects the content having the feature amount with higher similarity to the feature amount estimated by the feature amount estimating unit.

According to still another aspect of the present invention, a data search method includes obtaining a content and a first metadata corresponding to the content and including at least a search key indicating an object of the content; computing a feature amount from the obtained content; storing a learning-data that correspondingly includes the first metadata corresponding to each of the obtained content and the computed feature amount in a learning-data storing unit; reconstructing the learning-data by generating a second metadata from the first metadata included in the learning-data stored in the learning-data storing unit so that the second metadata includes all search keys in the first metadata of all the learning-data, and by replacing the first metadata by the second metadata in learning-data; and generating a model from the learning-data, the model being a coefficient matrix representing a relation between the feature amount and the search key of the generated second metadata.

According to still another aspect of the present invention, a data search method implemented in a data search apparatus that includes a content storing unit that correspondingly stores a content and a feature amount indicating a feature of the content, and a model storing unit that stores a model that is a coefficient matrix representing a relation between the feature amount and a search key of metadata including at least a search key indicating an object of the content, the method includes receiving an input of the metadata; estimating the feature amount based on the received metadata and the model stored in the model storing unit; and comparing the feature amount corresponding to each of the content stored in the content storing unit to the estimated feature amount, and selecting the content having the feature amount with higher similarity to the estimated feature amount.

### BRIEF DESCRIPTION OF THE DRAWINGS

FIG. 1 is a block diagram of a data search apparatus according to a first embodiment of the present invention;

FIG. 2 is a schematic diagram illustrating an example of an image data and metadata stored in a web-data storing unit;

FIG. 3 is a schematic diagram illustrating an example of a feature amount computed from the image data;

FIG. 4 is a schematic diagram illustrating an example of a learning-data generated by a learning-data generating unit;

FIG. 5 is a schematic diagram illustrating an example of data stored in a search-target data storing unit;

FIG. 6 is a flowchart of a model generating process performed by the data search apparatus;

FIG. 7 is a schematic diagram illustrating another example of the learning-data generated by the learning-data generating unit;

FIG. 8 is a schematic diagram illustrating an example of the learning-data reconstructed by a learning-data reconstructing unit;

FIG. 9 is a flowchart of a search-target data storing process performed by the data search apparatus;

FIG. 10 is a flowchart of a data search process performed by the data search apparatus;

FIG. 11 is a schematic diagram illustrating an example of the feature amount estimated by a feature amount estimating unit;

FIG. 12 is a schematic diagram illustrating an example of the learning-data of speech data;

FIG. 13 is a schematic diagram illustrating an example of the learning-data of text data; and

FIG. 14 is a block diagram of hardware configuration of the data search apparatus.

### DETAILED DESCRIPTION OF THE INVENTION

Exemplary embodiments of the present invention are described in detail below with reference to the accompanying drawings. The present invention is not limited to the embodiments, and various modifications can be made without departing from the scope of the invention.

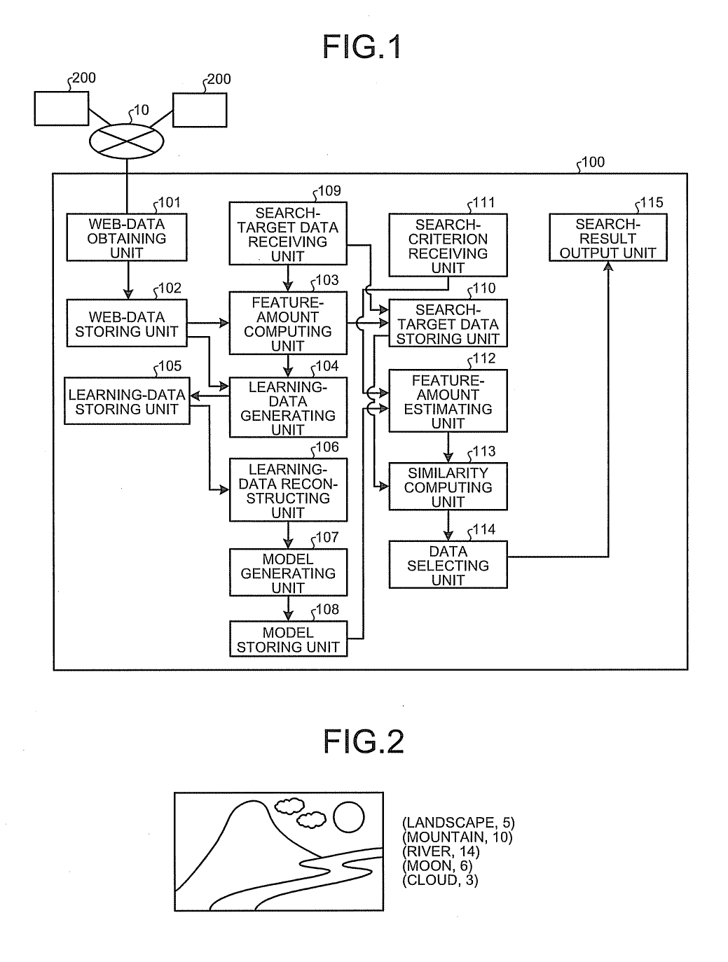

As shown in FIG. 1, a data search apparatus 100 according to a first embodiment of the present invention mainly includes a model generating section and a data search section. The data search apparatus 100 can be, for example, a typical personal computer.

The model generating section includes a web-data obtaining unit 101, a web-data storing unit 102, a feature amount computing unit 103, a learning-data generating unit 104, a learning-data storing unit 105, a learning-data reconstructing unit 106, a model generating unit 107, and a model storing unit 108. The data search section further includes a search-target data receiving unit 109, a search-target data storing unit 110, a search-criterion receiving unit 111, a feature amount estimating unit 112, a similarity computing unit 113, a data selecting unit 114, and a search-result output unit 115. The data search apparatus 100 is connected to at least one information processing devices 200 via a network 10.

The information processing device 200 stores therein image data and metadata of the data applied by many posters and readers. The metadata includes a search key that indicates a content of the image data and the number of times that the search key was applied. Although the first embodiment is explained using an example of the image data, any type of data shared on the network 10 can be used instead of the image data, including the speech data and the text data. A combination of these types of data can be also used. The data are collectively called contents. The image data includes still images and moving images. The search key is, for example, a keyword that indicates the content of the image data, and an explanation is given below citing an example of using the keyword as the search key.

The web-data obtaining unit 101 establishes a connection to the information processing device 200, which is a website that shares the image data and the metadata of the image data on the network 10, and obtains the image data and the metadata. Instead of obtaining the image data and the metadata from the information processing device 200 via the network 10, the web-data obtaining unit 101 can be configured to obtain the image data and the metadata that are input to the data search apparatus 100 by a user.

The web-data storing unit 102 stores therein the image data and the metadata obtained by the web-data obtaining unit 101 associated with each other. In the web-data storing unit 102, a piece of image data is associated with its metadata that includes the keyword and the number of times that the keyword was applied, such as “landscape, 5”, as shown in FIG. 2.

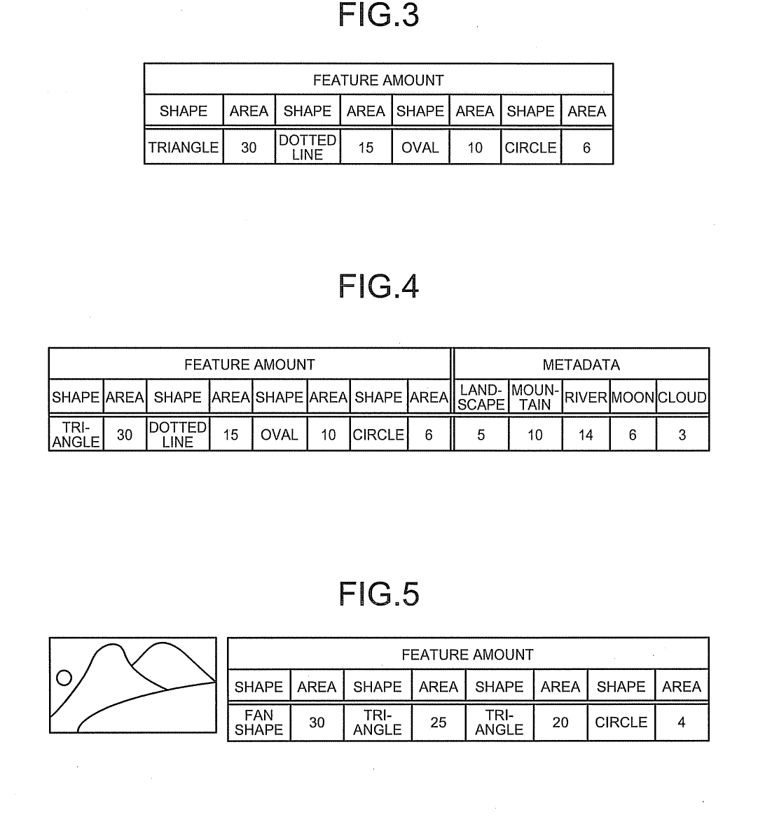

The feature amount computing unit 103 computes a plurality of feature amounts from the data stored in the web-data storing unit 102. The feature amount means information that indicates the feature of the image data, and it is specifically a combination of an item that features the image data and its value. In an example shown in FIG. 3, the feature amounts include the shapes of objects that appear in the image and percentage of the area occupied by each of the objects in the entire image.

To compute the feature amount of a moving image data, by using the watershed algorithm described in “Moving Object Extraction Using Background Difference and Region Growing with Spatio-temporal Watersheds”, Shinichi Sakaida, Masahide Naemra, and Yasuaki Kanatsugu, IEICE Transactions on Information and Systems, vol. J84-D2, No. 12, pp. 2541-2555, 2001, an area having a distinctive shape, e.g., the feature amount shown in FIG. 3, can be extracted from the moving image data.

To compute the feature amount of a still image data, by using the rectangle features described in “An Extended Set of Haar-like Features for Rapid Object Detection”, R. Lienhart and J. Maydt, Proc. of International Conference on Image Processing, vol. 1, pp. 900-903, 2002, an area corresponding to a rectangle feature pattern that is stored in advance, e.g., the feature amount shown in FIG. 3, can be extracted from the still image data. The feature amount of the image data is not limited to the items and the values shown in FIG. 3, and any other items and values can be used as long as they show the feature of the image data.

The feature amount computing unit 103 further computes a plurality of feature amounts from the image data input by the search-target data receiving unit 109 to be described later. The feature amount computing unit 103 can perform a simpler process of computing the feature amounts of the image data input by the search-target data receiving unit 109 to reduce the processing time.

The learning-data generating unit 104 generates learning-data from the metadata stored in the web-data storing unit 102 and the feature amount computed by the feature amount computing unit 103. The learning-data means a combination of the feature amount and the metadata of the image data, as shown in FIG. 4.

The learning-data storing unit 105 stores therein the learning-data generated by the learning-data generating unit 104. The learning-data storing unit 105 stores therein the learning-data with respect to each image data obtained by the web-data obtaining unit 101.

The learning-data reconstructing unit 106 reconstructs the keywords included in the metadata of a plurality of pieces of the learning-data stored in the learning-data storing unit 105. More specifically, the learning-data reconstructing unit 106 obtains all of the metadata in the learning-data stored in the learning-data storing unit 105, and generates new metadata that includes all of the keywords in the obtained metadata. If the keyword in the generated metadata is included in the learning-data stored in the learning-data storing unit 105, the learning-data reconstructing unit 106 increments the value corresponding to the keyword. If the keyword in the generated metadata is not included in the learning-data stored in the learning-data storing unit 105, the learning-data reconstructing unit 106 reconstructs the learning-data to include the keyword with its value set at zero, and stores the learning-data in the learning-data storing unit 105.

The model generating unit 107 generates a model that indicates a relation between the metadata and the feature amount from the learning-data stored in the learning-data storing unit 105. The model means a coefficient matrix that indicates the relation between the metadata and the feature amount. The model storing unit 108 stores therein the model generated by the model generating unit 107.

The search-target data receiving unit 109 receives the image data to be searched. More specifically, the search-target data receiving unit 109 receives the image data read by a scanner (not shown), a digital video device (not shown), or the like, or an image data drawn by an input device (not shown).

The search-target data storing unit 110 stores therein the image data received by the search-target data receiving unit 109 and the feature amount computed by the feature amount computing unit 103 associated with each other. More specifically, the search-target data storing unit 110 stores therein the image data and the feature amount associated with each other as shown in FIG. 5.

The search-criterion receiving unit 111 receives a search criterion for searching the image data stored in the search-target data storing unit 110. The search criterion means metadata, i.e., a single keyword or a combination of keywords. The keyword can include a value of weight corresponding to the number of times that the keyword was applied.

The feature amount estimating unit 112 estimates the feature amount corresponding to the search criterion based on the metadata, i.e., the search criterion, received by the search-criterion receiving unit 111, and the model stored in the model storing unit 108.

The similarity computing unit 113 computes a similarity to each piece of the image data from the feature amount of the image data stored in the search-target data storing unit 110 and the feature amount estimated by the feature amount estimating unit 112.

The data selecting unit 114 selects data having the similarity computed by the similarity computing unit 113 equal to or higher than a predetermined threshold from among the image data stored in the search-target data storing unit 110.

The search-result output unit 115 outputs the image data selected by the data selecting unit 114 as the search result.

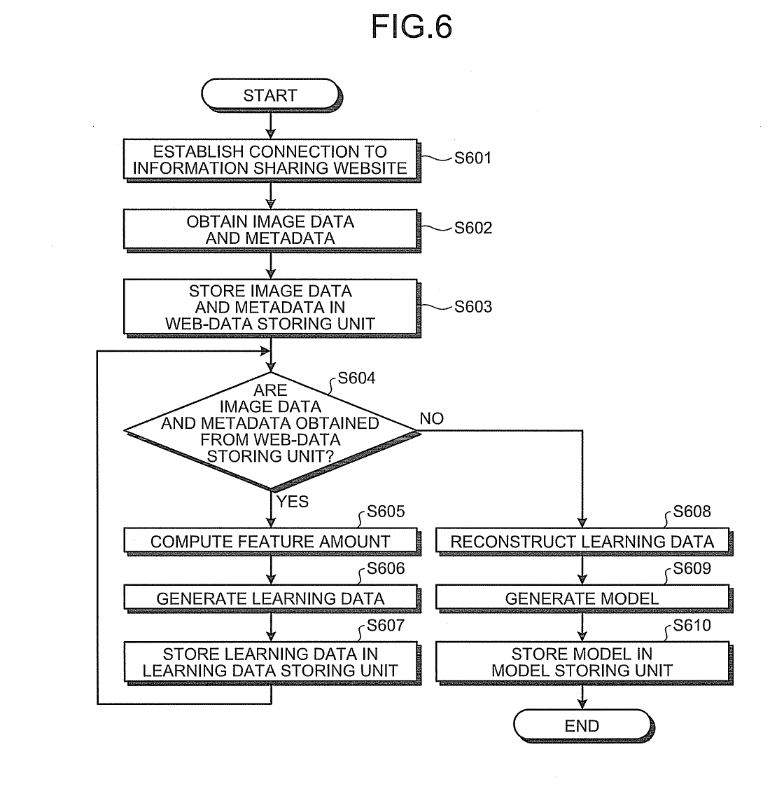

Next, a model generating process performed by the data search apparatus 100 is explained below with reference to FIG. 6.

First, the web-data obtaining unit 101 establishes a connection to the information processing device 200, which is an information sharing website, through the network 10 (Step S601). For example, the web-data obtaining unit 101 establishes a connection to the information processing device 200, such as a website “photozou (http://photozou.jp/)” for sharing movies and photographs, with which the web-data obtaining unit 101 shares the movies and the photographs as the image data, and keywords indicative of the contents of the movies and the photographs and the number of times that the keyword was applied as the metadata.

The web-data obtaining unit 101 then obtains the image data and the metadata from the information processing device 200 (Step S602). When the connection to the information processing device 200 is established, the web-data obtaining unit 101 downloads the movies and the photographs as the image data, and downloads the metadata including the keywords applied by the posters and the readers and the number of times that the keyword was applied. This enables use of the image data shared on the network 10, the keywords applied to the image data, and the number of times of applying the keywords to the image data as the metadata. In this manner, the data search apparatus 100 can obtain the image data, while greatly cutting down the labor to apply the metadata to the obtained image data.

The web-data obtaining unit 101 stores the obtained image data and the metadata associated with each other in the web-data storing unit 102 (Step S603). If a plurality of combinations of the image data and the metadata are obtained, the web-data obtaining unit 101 stores the combinations of the image data and the metadata in the web-data storing unit 102.

The feature amount computing unit 103 determines whether the image data and the metadata are obtained from the web-data storing unit 102 (Step S604). If the image data and the metadata are obtained (YES at Step S604), the feature amount computing unit 103 computes the feature amount from the image data and the metadata (Step S605). For example, from such an image as shown in FIG. 2, the feature amount computing unit 103 computes the shape of the object extracted from the image and the percentage of the area occupied by the object in the entire image as the feature amount. Alternatively, the feature amount can be a histogram showing the shade of black and white in the image, a histogram showing the chroma and the brightness, or the shape, the area, the barycenter, or the like of the object extracted from the image.

If the search-target data is speech data, i.e., waveform data, such as speech and music, for example, the feature amount computing unit 103 computes a coefficient obtained by Fourier transforming a frequency, an amplitude, or a waveform as the feature amount. If the search-target data is text data, the feature amount computing unit 103 computes the word stem, the word class, the modification relation between words, or the like, obtained by morphologically analyzing the text, as the feature amount. Alternatively, other information computed from the data can be used as the feature amount of the speech data and the text data.

The learning-data generating unit 104 generates learning-data by combining the feature amount computed by the feature amount computing unit 103 and the metadata obtained by the web-data obtaining unit 101 (Step S606). The learning-data generating unit 104 stores the generated learning-data in the learning-data storing unit 105 (Step S607).

If the image data and the metadata are not obtained (NO at Step S604), i.e., if all of the combinations of the image data and the metadata are obtained from the web-data storing unit 102, the learning-data reconstructing unit 106 reconstructs the generated learning-data (Step S608). More specifically, the learning-data reconstructing unit 106 constructs the vector including all of the keywords included in each piece of the metadata of the learning-data stored in the learning-data storing unit 105. At this time, if a keyword is applied to all but one piece of the learning-data, the learning-data reconstructing unit 106 reconstructs the learning-data by setting zero to the value of the keyword in the one piece of the learning-data.

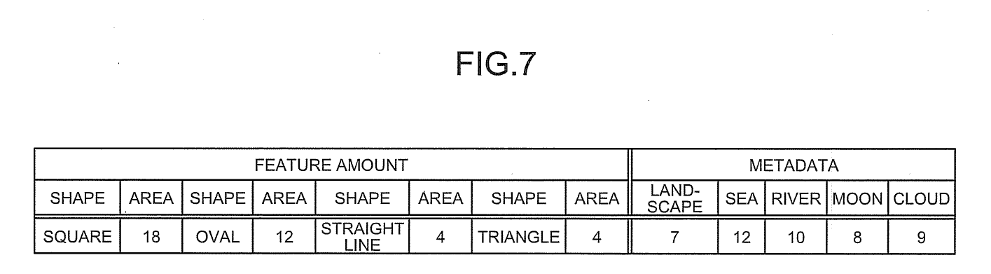

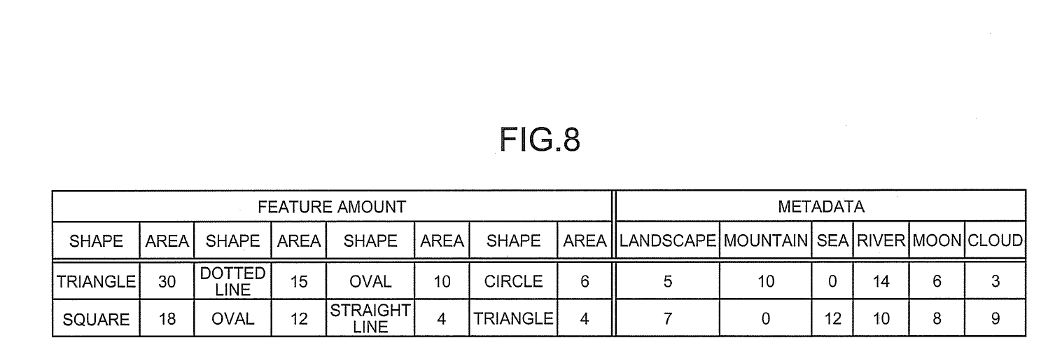

FIG. 7 is a schematic diagram illustrating an example of the learning-data generated by the learning-data generating unit 104, and FIG. 8 is a schematic diagram illustrating an example of the learning-data reconstructed by the learning-data reconstructing unit 106. When the two types of learning-data shown in FIGS. 4 and 7 are provided, the learning-data reconstructing unit 106 reconstructs a group of the learning-data from them as shown in FIG. 8. First, from the metadata shown in FIGS. 4 and 7, the learning-data reconstructing unit 106 generates a group of keywords included in one or both of the metadata, which includes “landscape”, “mountain”, “sea”, “river”, “moon”, and “cloud”. By reconstructing the learning-data shown in FIGS. 4 and 7 based on the group of keywords, the learning-data as shown in FIG. 8 is generated. For example, as shown in FIG. 8, the value “5” of the keyword “landscape” before the reconstruction is set to “landscape” in the learning-data reconstructed from the learning-data shown in FIG. 4, and “0” is set to the keyword “sea” because it was not included in the metadata before the reconstruction. By reconstructing the learning-data in this manner and generating a model based on the reconstructed learning-data, the data search apparatus 100 can generate a model to estimate the feature amount corresponding to the image data having a variety of contents.

The model generating unit 107 generates a model from the group of the learning-data (Step S609). For example, assuming that each keyword in the metadata is an explanatory variable, and that the shape and the percentage of the area of the feature amount is an explained variable, the metadata and the feature amount are obtained using:

Y=AX (1)

where Y is the feature amount, X is the metadata, and A is the model. In Equation (1), Y is (y₁, y₂, . . . yₘ), where yᵢ is the i-th feature amount among m feature amounts, X is (x₁, x₂, . . . , xₙ), where xⱼ is the number of times that the j-th keyword was applied among n keywords. The model A is a coefficient matrix of m×n that shows the relation between Y and X. The value of the coefficient matrix A is computed by performing a multiple regression analysis on the group of the learning-data. The model generating unit 107 stores the generated model in the model storing unit 108 (Step S610).

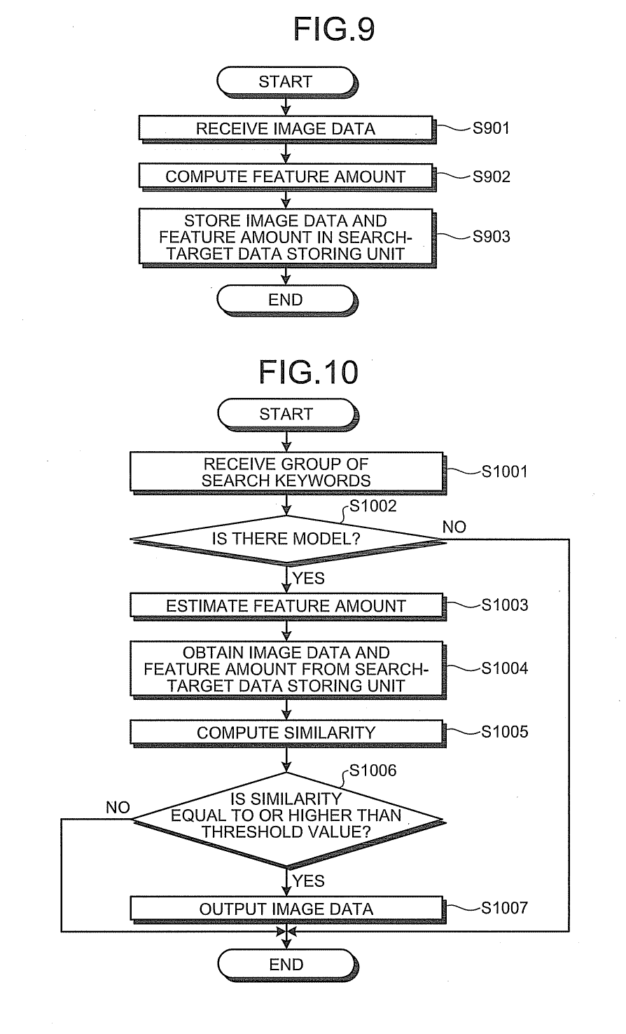

Next, a search-target data storing process performed by the data search apparatus 100 is explained below with reference to FIG. 9.

First, the search-target data receiving unit 109 receives the image data to be searched (Step S901). For example, the search-target data receiving unit 109 receives image data scanned by a scanner. The feature amount computing unit 103 computes the feature amount of the received image data (Step S902). The feature amount can be computed in the same method as used to compute the feature amount of the image data obtained by the web-data obtaining unit 101, or in a simpler method with less computing cost.

The feature amount computing unit 103 stores a combination of the image data and a plurality of feature amounts corresponding to the image data in the search-target data storing unit 110 (Step S903). For example, the feature amount computing unit 103 stores a combination of the image shown at the left of FIG. 5 and a plurality of feature amounts computed from the image shown at the right of FIG. 5 in the search-target data storing unit 110.

Next, a data search process performed by the data search apparatus 100 is explained below with reference to FIG. 10.

In the first embodiment, by comparing the feature amounts corresponding to the group of the search keywords estimated by the feature amount estimating unit 112 to the feature amounts corresponding to each piece of the image data stored in the search-target data storing unit 110, i.e., by evaluating the distance between feature amounts, the image data having similar feature amounts is selected as the image data that matches the search criterion. An example of selecting the image data using the similarity is explained below.

First, the search-criterion receiving unit 111 receives an input of a group of the search keywords as the search criterion (Step S1001). For example, the search-criterion receiving unit 111 receives the group of the keywords such as “mountain” and “moon”, which may possibly be applied to the image data as the metadata.

The feature amount estimating unit 112 determines whether a model is obtained from the model storing unit 108 (Step S1002). If the model is not obtained from the model storing unit 108 (NO at Step S1002), i.e., if the model storing unit 108 does not store therein any model, the process is terminated.

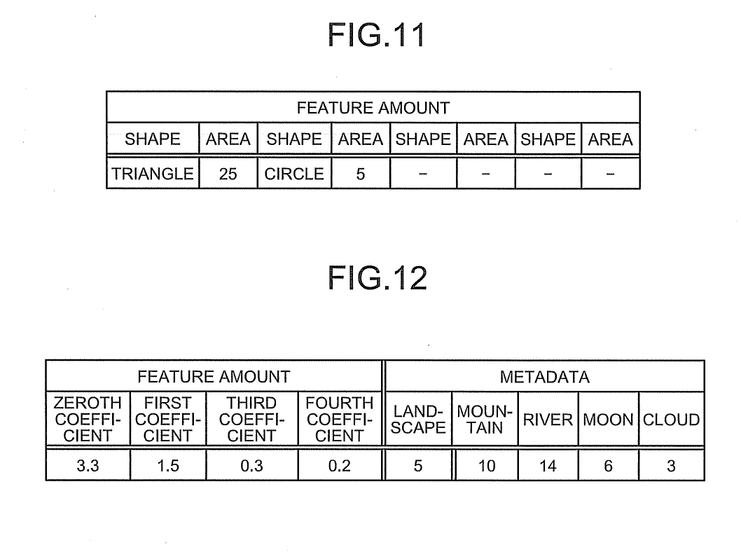

If the model is obtained from the model storing unit 108 (YES at Step S1002), the feature amount estimating unit 112 estimates the feature amount based on the model and the group of the keywords (Step S1003). In other words, by applying the group of the search keywords received by the search-criterion receiving unit 111 to the model, the feature amount estimating unit 112 estimates the feature amounts to be computed from the image data corresponding to the group of the search keywords. FIG. 11 is a schematic diagram illustrating an example of the feature amount estimated by the feature amount estimating unit 112. For example, if the group of the keywords “mountain” and “moon” is provided and the model is already generated, the feature amount estimating unit 112 estimates the feature amount as shown in FIG. 11.

The similarity computing unit 113 obtains the image data and the feature amount from the search-target data storing unit 110 (Step S1004). The similarity computing unit 113 computes the similarity between the feature amount corresponding to each piece of the image data and the feature amount estimated by the feature amount estimating unit 112 (Step S1005). The similarity between the two feature amounts is defined by:

$${similarity}_{k} = \frac{1}{\frac{1}{n} \times {\sum }_{i = 1}^{n} \{ {( {f}_{i} - {v}_{ik} )}^{2} + 1 \}} \qquad ( 2 )$$

where fᵢ is the i-th value of the feature amounts estimated from the group of the search keywords, and vᵢₖ is the i-th value of the feature amounts corresponding to the k-th piece of the image data stored in the search-target data storing unit 110.

The data selecting unit 114 determines whether the similarity computed by the similarity computing unit 113 with respect to each piece of the image data is equal to or higher than the threshold (Step S1006). If the similarity computed by the similarity computing unit 113 is equal to or higher than the threshold (YES at Step S1006), the search-result output unit 115 outputs all pieces of the image data of which the similarity is equal to or higher than the threshold (Step S1007). More specifically, the search-result output unit 115 displays the image data on a monitor (not shown). If the similarity computed by the similarity computing unit 113 is lower than the threshold (NO at Step S1006), the process is terminated.

In this manner, by generating models from a large amount of image data and metadata stored in the website on the network 10, the modeling accuracy is higher than generating models from automatically applied metadata, and therefore it is possible to search the image data that matches the search criterion from among the large amount of the search-target data with high accuracy. Furthermore, because of using the large amount of the search-target data and the metadata stored in the website on the network 10, there is no need of reading the image data for modeling and manually applying the metadata to the image data, thereby reducing the workload of the user.

Moreover, because of selecting the image data that matches the search criterion based on the model showing the relation between the feature amount computed by the image data and the metadata, there is no need of applying the metadata to each piece of the target image data, thereby reducing the workload of the user to store the image data as the search-target data.

The processes shown in FIGS. 6, 9, and 10 can be performed asynchronously. By clustering the metadata having similar feature amounts prior to generation of the model by the multiple regression analysis at Step S609, the multiple regression analysis can be performed after reducing a dimension of the learning-data.

Although the relation between the metadata and the feature amount is generated based on the multiple regression analysis at Step S609, the data search apparatus 100 can learn models using a machine learning method such as a neural network method.

Although the first embodiment was explained using the image data as the search-target data, the search-target data can be the speech data or the text data. When the search-target data is the speech data, a discrete Fourier coefficient obtained by fast Fourier transforming the waveform of the speech data can be used as the feature amount. FIG. 12 is a schematic diagram illustrating an example of the learning-data of the speech data. By fast Fourier transforming the waveform of the speech data, the learning-data including the feature amount and the metadata, as shown in FIG. 12, can be generated. In this case, the speech data is applied with the metadata shown in FIG. 2.

A procedure of computing the feature amount of the text data, when the search-target data is the text data, is explained below. First, by performing a morphologic analysis on the text data, the text is divided into words. The value of tf−idf defined by Equation (3) is computed with respect to each word, and a word vector is configured with the words having the tf−idf equal to or larger than a threshold.

$$tf - {idf}_{i} = \frac{1}{D} \cdot {log}_{2} ( \frac{D}{{d}_{1}} ) \cdot {\sum }_{j} \frac{{log}_{2} ( {t}_{ij} + 1 )}{{log}_{2} {w}_{j}} \qquad ( 3 )$$

where D is the total number of texts, dᵢ is the number of texts that include the i-th word, wⱼ is the number of words included in the j-th text, and tᵢⱼ is the number of the i-th word included in the j-th text. By using Equation (3), an influence by words that frequently appear in many sentences can be effectively removed from the word frequency.

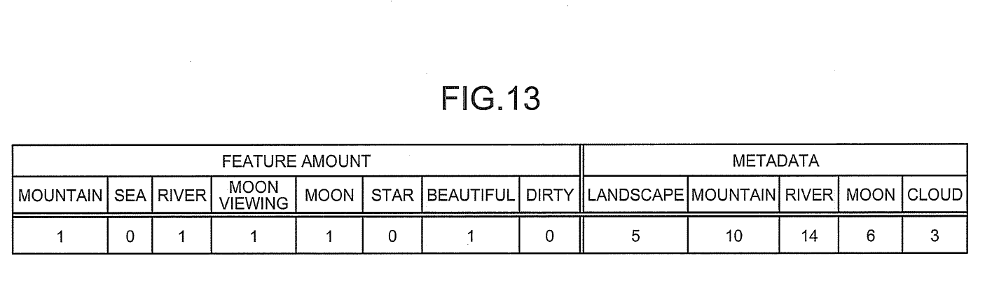

The learning-data of the text data includes word vectors that indicate one when the text data includes the word in the word vector, and that indicate zero when the text data does not include the word in the word vector, as shown in FIG. 13. For example, when the given text is “When we went camping in the mountain, we enjoyed moon viewing by the river. The moon was very beautiful.”, and words extracted by the determination of the tf−idf values are “mountain”, “sea”, “river”, “moon viewing”, “moon”, star”, “beautiful”, “dirty”, the learning-data as shown in FIG. 13 can be generated. In this case, the text data is applied with the metadata shown in FIG. 2.

A hardware configuration of the data search apparatus 100 is explained below. Although an example of applying the data search apparatus 100 to the typical personal computer is explained above, the present invention is not limited to using such a personal computer. Alternatively, the data search apparatus 100 can be applied to any type of device, such as a printer, as long as the device can be used to search contents.

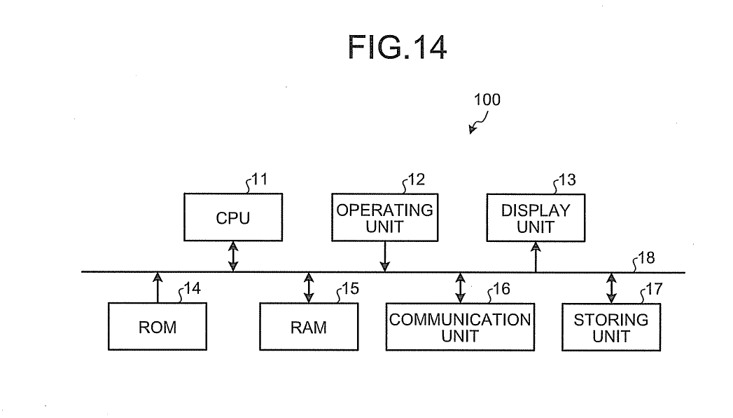

As shown in FIG. 14, the data search apparatus 100 includes a read only memory (ROM) 14 that stores therein a data search program and the like, a central processing unit (CPU) 11 that controls each unit of the data search apparatus 100 based on the computer program stored in the ROM 14, a random access memory (RAM) 15 that stores therein various types of data used to control the data search apparatus 100, a communication unit 16 that establishes a connection to a network for communication, a storing unit 17 that rewritably stores therein the computer programs and setup information for controlling the data search apparatus 100, a display unit 13 that displays the result of processing by the data search apparatus 100, an operating unit 12 through which the user inputs a processing command or the like, and a bus 18 that connects the units one another.

The web-data storing unit 102, the learning-data storing unit 105, the model storing unit 108, and the search-result output unit 115 can be configured by any type of commonly-used recording media, such as a hard disk drive (HDD), an optical disk, and a memory card.

The computer program executed by the data search apparatus 100 can be provided as recorded in a computer readable recording medium such as a compact disk read only memory (CD-ROM), a flexible disk (FD), and a digital versatile disk (DVD) in an installable or executable format.

In this case, when the data search apparatus 100 reads the computer program from the recording medium and executes it, thereby loading the computer program into the RAM 15 and generating the units explained above in the RAM 15.

The data search apparatus 100 can be otherwise configured so that the computer program executed by the data search apparatus 100 is preinstalled in the ROM 14. The computer program includes modules including the units described above. As actual hardware, by the CPU 11 reading the computer program from the recording medium and executing it, the units are loaded into a main memory and they are generated in the main memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data search apparatus comprising:
an obtaining unit that obtains a content and a first metadata corresponding to the content and including at least a search key indicating an object of the content;
a feature amount computing unit that computes a feature amount indicating a feature of the content from the content obtained by the obtaining unit;
a learning-data storing unit that stores a learning-data that correspondingly includes the first metadata corresponding to each of the content obtained by the obtaining unit and the feature amount computed by the feature amount computing unit;
a learning-data reconstructing unit that reconstructs the learning-data by generating a second metadata from the first metadata included in the learning-data stored in the learning-data storing unit so that the second metadata includes all search keys in the first metadata of all the learning-data, and by replacing the first metadata by the second metadata in learning-data; and
a model generating unit that generates a model from the learning-data, the model being a coefficient matrix indicating a relation between the feature amount and the search key in the second metadata generated.

2. The apparatus according to claim 1, further comprising:
a content storing unit that correspondingly stores the content and the feature amount;
a model storing unit that stores the model;
a receiving unit that receives an input of the first metadata;
a feature amount estimating unit that estimates the feature amount based on the first metadata received by the receiving unit and the model stored in the model storing unit; and
a selecting unit that compares the feature amount corresponding to each of the content stored in the content storing unit to the feature amount estimated by the feature amount estimating unit, and that selects the content having the feature amount with higher similarity to the feature amount estimated by the feature amount estimating unit.

3. The apparatus according to claim 2, further comprising a similarity computing unit that computes a similarity between the feature amount corresponding to each of the contents stored in the content storing unit and the feature amount estimated by the feature amount estimating unit, wherein the selecting unit selects the content having the similarity equal to or higher than a predetermined threshold value.

4. A data search apparatus comprising:
a content storing unit that correspondingly stores a content and a feature amount indicating a feature of the content;
a model storing unit that stores a model that is a coefficient matrix representing a relation between the feature amount and a search key of metadata including at least a search key indicating an object of the content;
a receiving unit that receives an input of the metadata;
a feature amount estimating unit that estimates the feature amount based on the metadata received by the receiving unit and the model stored in the model storing unit; and
a selecting unit that compares the feature amount corresponding to each of the content stored in the content storing unit to the feature amount estimated by the feature amount estimating unit, and that selects the content having the feature amount with higher similarity to the feature amount estimated by the feature amount estimating unit.

5. The apparatus according to claim 1, wherein the content is an image data.

6. The apparatus according to claim 5, wherein the feature amount includes a shape of a graphic included in the image data and an area that the shape occupies in an entire area of the image data.

7. The apparatus according to claim 1, wherein the content is an speech data.

8. The apparatus according to claim 7, wherein the feature amount is a discrete Fourier coefficient obtained by fast Fourier transforming a waveform of the speech data.

9. The apparatus according to claim 1, wherein the content is a text data.

10. The apparatus according to claim 9, wherein the feature amount is a word included in the text data.

11. A data search method comprising:
obtaining a content and a first metadata corresponding to the content and including at least a search key indicating an object of the content;
computing a feature amount from the obtained content;
storing a learning-data that correspondingly includes the first metadata corresponding to each of the obtained content and the computed feature amount in a learning-data storing unit;
reconstructing the learning-data by generating a second metadata from the first metadata included in the learning-data stored in the learning-data storing unit so that the second metadata includes all search keys in the first metadata of all the learning-data, and by replacing the fist metadata by the second metadata in learning-data; and
generating a model from the learning-data, the model being a coefficient matrix representing a relation between the feature amount and the search key of the generated second metadata.

12. A data search method implemented in a data search apparatus that includes a content storing unit that correspondingly stores a content and a feature amount indicating a feature of the content, and a model storing unit that stores a model that is a coefficient matrix representing a relation between the feature amount and a search key of metadata including at least a search key indicating an object of the content, the method comprising:
receiving an input of the metadata;
estimating the feature amount based on the received metadata and the model stored in the model storing unit; and
comparing the feature amount corresponding to each of the content stored in the content storing unit to the estimated feature amount, and selecting the content having the feature amount with higher similarity to the estimated feature amount.
